(19) United States
(12) Patent Application Publication
(10) Pub. No.: US 2013/0276839 A1
(43) Pub. Date: Oct. 24, 2013

(54) HYDRODYNAMIC MULTIPURPOSE WASHING DEVICE INCLUDING DETERGENT

(71) Applicant: Wan Ki Yoo, Gyeonggi-do (KR)

(72) Inventor: Wan Ki Yoo, Gyeonggi-do (KR)

(21) Appl. No.: 13/976,153

(22) PCT Filed: Nov. 30, 2011
(86) PCT No.: PCT/KR11/09183

§ 371 Date: Jun. 26, 2013

(30) Foreign Application Priority Data
Dec. 30, 2010 (KR) 10-2010-0138807

(51) Int. Cl. B08B 3/02

(52) U.S. Cl. CPC B08B 3/02
USPC 134/99.2

(57) ABSTRACT

The present invention relates to a hydrodynamic multipurpose washing device including a detergent, wherein the spray pressure is increased by even a small flux to maximize cleaning power using only the hydraulic pressure of tap water without a separate pressurization device such as a pressure pump, a detergent is combined and is diluted with water to be sprayed to facilitate the washing of an oil components and protein components which are difficult to be washed off with pure water, and a brush for removing solidified foreign matter and reducing washing time is provided to facilitate washing selections according to a need.

### CROSS-REFERENCE TO RELATED APPLICATION

This application claims the benefit of Korean Patent Application No.10-2010-0138807, filed on Dec. 30, 2010 in the Korean Intellectual Property Office, the disclosure of which is incorporated herein by reference.

### TECHNICAL FIELD

The present invention relates to a hydrodynamic multipurpose washing device including a detergent, and more particularly, to a hydrodynamic multipurpose washing device including a detergent that can maximize cleaning power by increasing an ejection pressure with a small flux using only a water pressure of a water tap without using a separate pressing device like a pressure pump and that can mix and eject the provided detergent together with water for easy washing of an oil component and a protein component in which pure water washing is difficult and that has a brush for removing a solidified foreign substance and shortening a washing time and that can easily select a washing method, as needed.

### BACKGROUND ART

In general, when compressed air of a compressor or a fluid compressed with a high pressure pump passes through a narrow pipe channel, there is an example of providing an organic solvent, a detergent, or an abrasive at the side end of the pipe channel and washing with the organic solvent, detergent, or abrasive, and such a structure and principle are described as “Bernoulli's theorem”.

The present applicant filed a dish washing device for washing vegetables, fruit, and dishes including a dish detergent using such Bernoulli's theorem as Korean Utility Model Application Laid-open No. 20-2010-0007001.

When the dish washing device for washing vegetables, fruit, and dishes including a dish detergent adjusts a water temperature and a water amount (water pressure) appropriate for washing dishes by a water valve, supplies water to an ejection nozzle through a water injection pipe, and ejects water in a high pressure, the detergent housed in a detergent storage tub can be supplied through a detergent injection pipe, and the dish washing device has a structure of opening and closing a detergent orifice by rotating an adjustment valve in a screw direction, and when ejecting water of a high pressure, the dish washing device has a structure of supplying the detergent by a pressure difference, and by installing a handle at the outside of the dish washing device, a use direction of the dish washing device can be freely set.

However, the detergent is ejected by a pressure difference of water that passes through a water injection orifice, and when a large amount of detergent is necessary, an amount of the detergent cannot be adjusted and thus when bubble washing like washing of dishes having oiliness, a protein component, or starch is necessary, there was a drawback that water is consumed for a long time.

Further, in a conventional automatic dish washing device, there is a drawback that concave dishes or convex dishes should be divided according to a shape of dishes and the dishes should be disposed according to a washing nozzle direction, and as the dish washing device should be operated for a predetermined time regardless of more or less of washing objects, water and electrical energy may be consumed, and even after washing is complete, there is a problem that a residual substance of a dish exclusive detergent may remain to be injected into a human body.

In hand washing using a scrubber and a detergent, when washing dishes of a recessed groove or a net structure, a scrubber, a sponge, and a brush corresponding to the dishes should be separately prepared, and when washing clothing or footwear, there was a problem that a corner portion or an uneven portion is insufficiently washed and a washing object is damaged.

### DISCLOSURE

### Technical Problem

The present invention is made to overcome the above mentioned problems, and it is an object of the present invention to provide a hydrodynamic multipurpose washing device including a detergent that can save energy with no power because electricity is not used and that reduces a water amount area and increases an ejection pressure with a water pressure of water discharged from a water tap by mounting the hydrodynamic multipurpose washing device in an end portion of a water valve and that can eject water in a high pressure while adjusting an ejecting amount of a detergent and a water amount and that is formed to mix and eject a detergent to water in order to easily remove oiliness and a protein component and that installs a brush in order to remove a hardened foreign substance and that can wash rippled or curved vegetables or fruits and clothing or footwear as well as dishes and that can select pure water washing, bubble washing, and brush washing for a multipurpose according to use.

### Technical Solution

To achieve the above objects, there is provided a hydrodynamic multipurpose washing device including a detergent,
mounted in an end portion of a water valve and for adjusting and ejecting a detergent ejection amount and a water amount in a high pressure while increasing an ejection pressure and reducing a flowing water amount area through a water pressure of water discharged from a water tap,
the hydrodynamic multipurpose washing device including:
an I-shape body;
an ejecting nozzle positioned at a head portion of the body to perform bubble washing and rinse washing of a washing object by ejecting a detergent and water in a high pressure through an internal orifice pipe;
a flow channel pipe positioned at the rear end of the ejection nozzle to integrally connect between the ejection nozzle and a water pressure adjusting unit and for supplying a detergent and water toward the ejection nozzle;
the water pressure adjusting unit positioned at the rear end of the flow channel pipe to adjust an amount of water in order to inject water together with the detergent into the ejection nozzle by adjusting a water pressure of water discharged from the water tap; and
a water supply valve connected to the rear end of the water pressure adjusting unit and the end portion of the water valve to supply water discharged from the water tap to the water pressure adjusting unit.

### Advantageous effects

As described above, in the present invention, a large amount of dishes can be washed in a short time as well as clean washing of dishes of a uneven shape or a net structure, and when washing clothing or footwear, a corner portion or an uneven portion can be washed, the clothing or the footwear can be washed without rubbing contaminated clothing or without using a special detergent and without damaging a washing object, and energy can be saved with a method of not requiring separate power and installation or movement thereof is convenient.

### BRIEF DESCRIPTION OF DRAWINGS

FIG. 1 is a perspective view illustrating a constituent element of a hydrodynamic multipurpose washing device 1 including a detergent according to an exemplary embodiment of the present invention.

FIG. 2 is an internal perspective view illustrating a constituent element of a hydrodynamic multipurpose washing device including a detergent according to an exemplary embodiment of the present invention.

FIG. 3 is a cross-sectional view illustrating a process of returning a piston to an original state by a restoring force of a compression coil spring of a detergent storage tub by positioning a water pressure adjusting unit at a detergent injection OFF display scale and by closing between a water injecting vent hole and a straight type stop bar according to an exemplary embodiment of the present invention.

FIG. 4 is a cross-sectional view illustrating a process of injecting a detergent housed in a detergent storage tub toward a detergent injection orifice pipe, as a pushing force occurs at a piston by injecting water flowing to only a water supply flow channel pipe into a piston space portion 45a through a water injection vent hole, by positioning a water pressure adjusting unit at a detergent injection ON display scale and by opening between a water injecting vent hole and a straight type stop bar according to an exemplary embodiment of the present invention.

FIG. 5 is a perspective view illustrating a process in which water flowing to only a water supply channel pipe is injected into a piston space portion 45a through a water injecting vent hole, as a gap occurs between a straight type stop bar and a water injecting vent hole, when a straight type stop bar of a water pressure adjustment valve corresponds to a water injecting vent hole while forming a pair with the water injecting vent hole in a horizontal direction according to an exemplary embodiment of the present invention.

FIG. 6 is a perspective view illustrating a process in which water injection is turned off and a piston is returned to an original state by a restoring force of a compression coil spring of a detergent storage tub when a straight type stop bar of a water pressure adjustment valve forms an angle θ 45°-90° with a water injecting vent hole according to an exemplary embodiment of the present invention.

### BEST MODES FOR CARRYING OUT THE INVENTION

Hereinafter, an exemplary embodiment of the present invention will be described with reference to the accompanying drawings.

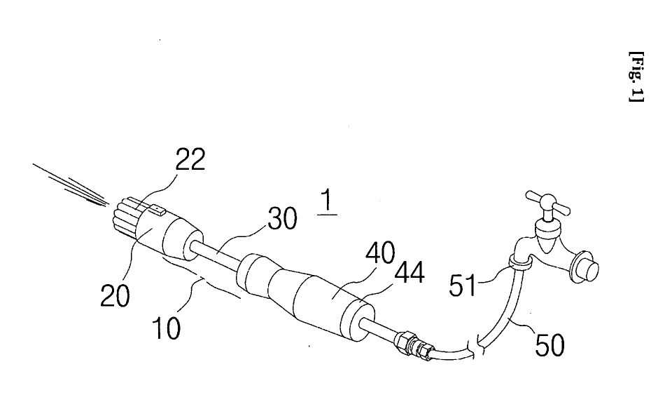

FIG. 1 is a perspective view illustrating a constituent element of a hydrodynamic multipurpose washing device 1 including a detergent according to an exemplary embodiment of the present invention, and the hydrodynamic multipurpose washing device 1 includes an I-shaped body 10, an ejecting nozzle 20, a flow channel pipe 30, a water pressure adjusting unit 40, and a water supply valve 50.

First, the I-shaped body 10 according to an exemplary embodiment of the present invention will be described.

The I-shaped body 10 performs a function of supporting the ejection nozzle, the flow channel pipe, the water pressure adjusting unit, and the water supply valve, and in a head portion of the I-shaped body 10, a cylindrical drum-shaped ejection nozzle is formed, in a rear end portion thereof, a cylindrical drum-shaped water pressure adjusting unit is formed, a rod-shaped flow channel pipe is connected between the ejecting nozzle and the water pressure adjusting unit and thus the I-shaped body is formed.

The I-shaped body 10 according to an exemplary embodiment of the present invention is made of aluminum alloy steel or a synthetic resin material.

Hereinafter, the ejecting nozzle 20 according to an exemplary embodiment of the present invention will be described.

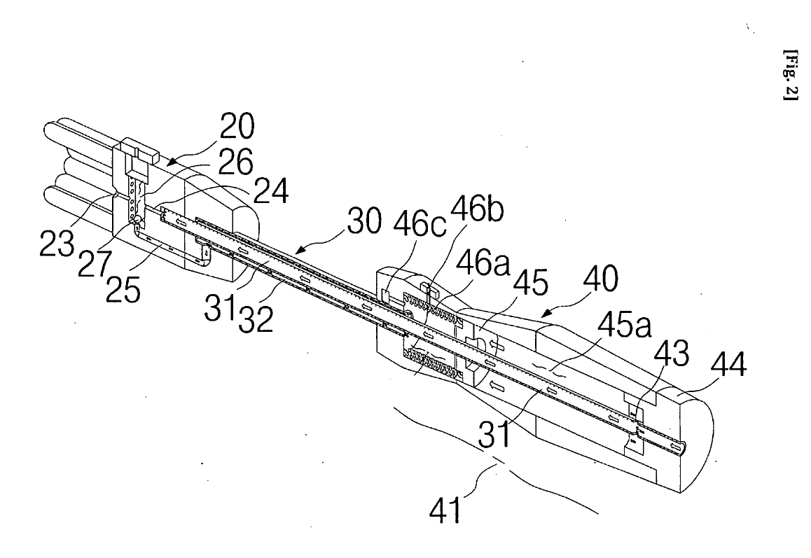

The ejecting nozzle 20 is positioned at the head portion of the body to perform bubble washing and rinse washing a washing object by ejecting a detergent and water in a high pressure through an internal orifice pipe, and as shown FIG. 2, the ejecting nozzle 20 includes a brush 22 formed in a cylindrical drum shape and for washing a washing object along a circumference of the front end, an ejecting port 23 for ejecting a detergent and water in a high pressure from the center of the front end toward the washing object, a water injection orifice pipe 24 for reducing a water amount area and increasing a water ejecting pressure in an internal direction of the rear end of the ejecting port, and a detergent injection orifice pipe 25 positioned in a direction of an angle 90° from one side of the water injection orifice pipe to reduce a detergent amount area and to increase a detergent ejection pressure.

The ejecting port 23 has a half circular arc shape and has an ejection angle adjustment link means for adjusting an ejection angle to 5°-70° at an end portion thereof.

Thereby, an ejection angle of water and the detergent may be adjusted to 5°-70°.

The water injection orifice pipe 24 and the detergent injection orifice pipe 25 perform a function of increasing an ejection pressure by reducing an area after injection of water and the detergent, compared with an area before injection of water and the detergent.

This is performed through a principle of Bernoulli's equation.

Here, when a fluid flows while forming a flow line (streamline), Bernoulli's equation represents a relationship between a height of two points A and B, a pressure at the two points, and a flow speed with numerical formulas based on that mechanical energy is preserved at the two points.

That is, position energy is represented with a height h from a reference point, kinetic energy is represented with a speed v in which fluid flows, and a work (energy) is represented with a pressure P, and Bernoulli's equation represents that at any one point, the sum of the three energies is the same as the sum of three energies at another point. In this case, it is assumed that a density of a fluid is not changed. Further, position energy or kinetic energy of a fluid should be represented with a density p, and the pressure is not the same as a pressure when a fluid is stationary.

This may be represented by Equation 1 and Equation 2.

P+ρgh+ at 1/2ρv2=constant [Equation 1]

where P is a pressure, ρ is a density, g is acceleration of gravity, h is a height from a reference point, and v is a flow speed of a fluid.

PA+ρghA+1/2ρvA2=PB+ρghB+1/2ρvB2 [Equation 2]

where P is a pressure, ρ is a density, g is acceleration of gravity, h is a height from a reference point, and v is a flow speed of a fluid.

Further, the ejecting nozzle 20 according to an exemplary embodiment of the present invention includes a mixing space portion 26 formed in portion in which the water injection orifice pipe and the detergent injection orifice pipe meet and a detergent check valve 27 for checking to inject a detergent in only an ejecting port direction in the mixing space portion.

In the mixing space portion 26, the water injection orifice pipe and the detergent injection orifice pipe meet while forming an angle 90°, and the mixing space portion 26 is space that mixes a detergent to water by a water pressure ejected to the water injection orifice pipe. A detergent together with water is ejected to an ejecting port by a water pressure of a horizontal direction ejected from the water injection orifice pipe.

In order to inject the detergent to one direction of the ejecting port side, the detergent check valve 27 is installed at the mixing space portion.

The detergent check valve 27 is a pressure adjustment type check valve that can adjust a reference pressure to 1.0 bar-4.5 bar.

That is, when the detergent check valve sets a reference pressure to 1.0 bar, if a pressure of a detergent injected toward the detergent injection orifice pipe is 1.0 bar or more, the detergent check valve is opened, and if a pressure of a detergent is 1.0 bar or less, the detergent check valve is closed.

Hereinafter, the flow channel pipe 30 according to an exemplary embodiment of the present invention will be described.

The flow channel pipe 30 is positioned at the rear end of the ejecting nozzle to integrally connect the ejecting nozzle and the water pressure adjusting unit and performs a function of supplying a detergent and water toward the ejecting nozzle.

The flow channel pipe 30 includes a water supply flow channel pipe 31 and a detergent flow channel pipe 32.

The water supply flow channel pipe 31 performs a function of injecting water discharged according to a water pressure adjusted through the water pressure adjusting unit into a water injection orifice pipe of the ejecting nozzle.

The detergent flow channel pipe 32 is formed at a circumference of the water supply flow channel pipe to perform a function of injecting a detergent to the detergent injection orifice pipe of the ejecting nozzle by a pushing force of a piston.

Hereinafter, the water pressure adjusting unit 40 according to an exemplary embodiment of the present invention will be described.

The water pressure adjusting unit 40 is positioned at a rear end portion of the flow channel pipe to perform a function of adjusting an amount of water to be injected into the ejecting nozzle together with a detergent by adjusting a water pressure of water discharged from a water tap, and as shown in FIG. 2, the water pressure adjusting unit 40 includes a cylindrical drum-shaped water pressure adjustment body 41, the water supply flow channel pipe 31 penetrated at the center of the inside of the water pressure adjustment body, a water injecting vent hole 43 for injecting water toward a piston space portion to generate a force pushing with a water pressure to a detergent piston at one side of the water supply flow channel pipe positioned at a rear end portion of the water pressure adjustment body, a water pressure adjustment valve 44 positioned at one side of the water injecting vent hole to adjust a water pressure with a straight type stop bar rotation method, a piston 45 positioned in a front end direction of an internal piston space portion 45a of the water pressure adjustment valve to push a detergent of a detergent storage tub toward the detergent injection orifice pipe, and the detergent storage tub 46 for storing a detergent at the front end of the piston.

The water pressure adjustment valve 44 is positioned at one side of a water injecting vent hole to perform a function of adjusting a water pressure, and the water pressure adjustment valve 44 is formed in a cylindrical layer-shaped structure, and in a head portion contacting with the water injecting vent hole formed in the water supply flow channel pipe 31, a straight type stop bar is depressed.

That is, as shown in FIG. 6, when the straight type stop bar forms an angle 45°-90° from the water injecting vent hole, water injection is turned off, and when a piston is returned to an original state by a restoring force of a compression coil spring of the detergent storage tub, ejection of a detergent is turned off.

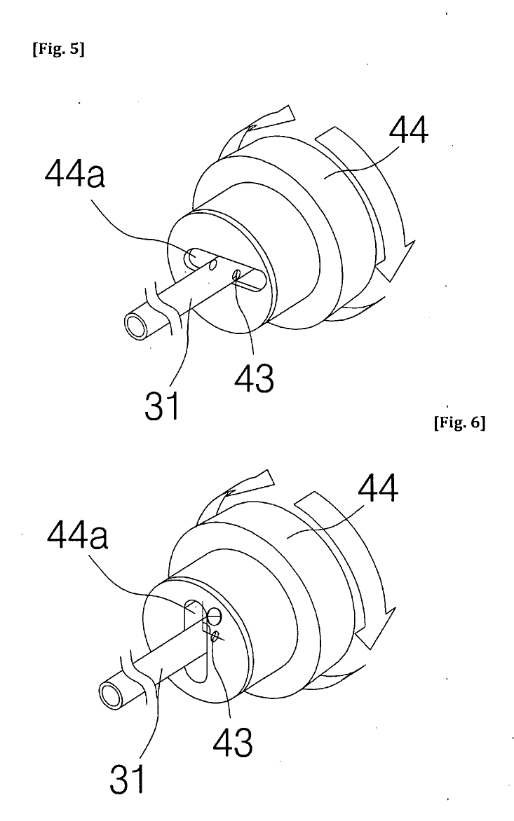

In contrast, as shown in FIG. 5, when the straight type stop bar corresponds to the water injecting vent hole while forming a set with the water injecting vent hole in a horizontal direction, a gap occurs between the straight type stop bar and the water injecting vent hole and thus water flowing to only a water supply flow channel pipe is injected into the piston space portion 45a through the water injecting vent hole.

In this case, water injected into the piston space portion generates a force pushing the piston, the piston having the pushing force pushes again the detergent storage tub and thus the detergent housed in the detergent storage tub is injected toward the detergent injection orifice pipe.

A water pressure adjustment valve according to of an exemplary embodiment of the present invention is coupled to a rear end portion of the water pressure adjustment body in a stop pin structure or a stop ring structure and adjusts a water pressure according to sealing and opening between the water injecting vent hole and the straight type stop bar.

When a stop pin is inserted, the stop pin structure is a structure that only rotates in a fixed state and that elastically supports to prevent the stop pin from separating to the rear side by a water pressure.

In the stop ring structure, a C-shaped ring is inserted into the stop ring and is spread and fixed to the inside of the structure and thus performs only a rotation and the stop ring structure elastically supports to prevent the C-shaped ring from separating to the rear side by a water pressure.

Further, the water pressure adjusting unit according to an exemplary embodiment of the present invention sets a display scale of detergent injection ON and detergent injection OFF at an external surface of a water pressure adjustment body and adjusts the water pressure adjustment valve according to a use purpose.

The piston 45 performs a forward movement by a pushing force of water injected into a piston space portion to inject a detergent stored at the detergent storage tub toward the detergent injection orifice pipe, and after a work is complete, when water injection is turned off, the piston is returned to an original state by a restoring force of a compression coil spring of the detergent storage tub.

The detergent storage tub 46 includes a compression coil spring 46a for restoring the piston to an original state after a work is complete at a periphery of a latch jaw of an end portion of the water pressure adjustment body and a portion contacting with the piston, a detergent cap 46b for supplying a detergent to the inside at one side of an outside circumference, and an air check valve 46c for checking to inject air injected into the front end of a latch jaw of an end portion of the water pressure adjustment body in a detergent injection orifice pipe direction.

Hereinafter, the water supply valve 50 according to an exemplary embodiment of the present invention will be described.

The water supply valve 50 is connected to a rear end portion of the water pressure adjusting unit and an end portion of the water valve to supply water discharged from a water tap to the water pressure adjusting unit, and the water supply valve 50 is made of a synthetic resin and is formed in a length of 1-10 m according to a use purpose to be connected to the rear end portion of the water pressure adjusting unit and the end portion of the water valve.

When the water supply valve is connected to the end portion of the water valve, a detachable connecting valve forming a pair with the water valve is installed.

Hereinafter, a detailed operation process of a hydrodynamic multipurpose washing device including a detergent according to an exemplary embodiment of the present invention will be described.

First, the water supply valve is connected to the end portion of the water valve.

In this case, the water supply valve is connected through a detachable connecting valve forming a pair with the water valve.

Next, by turning the water valve, water discharged from the water tap is injected along the flow channel pipe and is ejected to a washing object in a high pressure through the ejecting nozzle.

Next, when wanting to eject a detergent to the washing object, ejection of the detergent is adjusted by turning the water pressure adjustment valve.

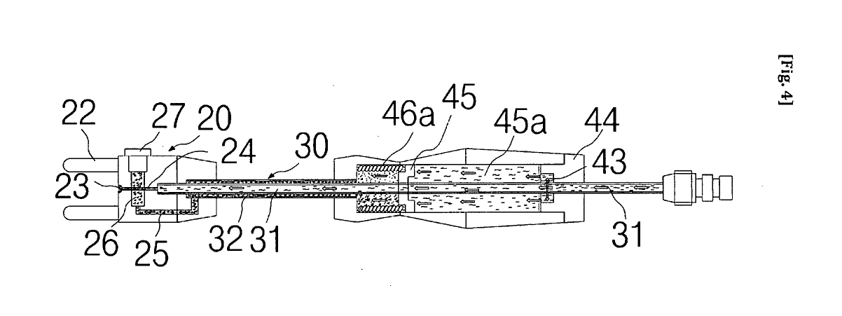

That is, as shown in FIG. 5, as the water pressure adjustment valve is rotated, the straight type stop bar corresponds to the water injecting vent hole while forming a pair with the water injecting vent hole, and as shown in FIG. 4, a gap occurs between the straight type stop bar and the water injecting vent hole and thus water flowing to only the water supply flow channel pipe is injected into the piston space portion through the water injecting vent hole.

Thereafter, water injected into the piston space portion generates a force pushing the piston and the piston having a pushing force pushes again the detergent storage tub, and thus the detergent housed within the detergent storage tub is injected toward the detergent injection orifice pipe.

Thereafter, when the detergent is injected toward the detergent injection orifice pipe, the detergent is injected into a mixing space portion, which is a portion in which the water injection orifice pipe and the detergent injection orifice pipe meet.

Thereafter, when water is ejected in a horizontal direction from the mixing space portion, the detergent together with water is ejected in a high pressure through an ejecting port to be ejected to the washing object.

Thereafter, bubble washing of the washing object is performed through a brush formed at a front end circumference of the ejecting nozzle, and when detergent ejection is turned off through the water pressure adjusting unit, only pure water is ejected to the washing object and thus rinse washing is performed.

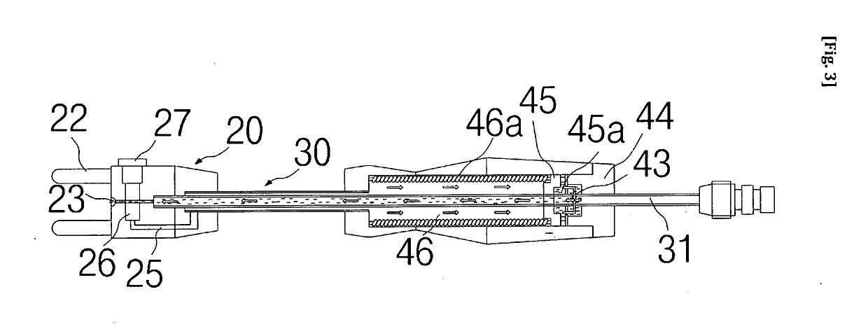

Here, when detergent ejection is turned off through the water pressure adjusting unit, as shown in FIG. 6, if a straight type stop bar forms an angle of 5°-85° with the water injecting vent hole by the water pressure adjustment valve, as shown in FIG. 3, water injection is turned off, and the piston is restored to an original state by a restoring force of the compression coil spring of the detergent storage tub and thus detergent ejection is turned off.

In this case, while the piston is restored to an original state, water remaining in the piston space portion is injected again into the water supply flow channel pipe 31 through the water injecting vent hole and is discharged to the outside through the ejecting port.

1. A hydrodynamic multipurpose washing device comprising a detergent, mounted in an end portion of a water valve and for adjusting and ejecting a detergent ejection amount and a water amount in a high pressure while increasing an ejection pressure and reducing a water amount area flowing through a water pressure of water discharged from a water tap, the hydrodynamic multipurpose washing device comprising:
an I-shape body 10;
an ejecting nozzle 20 positioned at a head portion of the body to perform bubble washing and rinse washing of a washing object by ejecting a detergent and water in a high pressure through an internal orifice pipe;
a flow channel pipe 30 positioned at the rear end of the ejection nozzle to integrally connect between the ejection nozzle and a water pressure adjusting unit and for supplying a detergent and water toward the ejection nozzle;
the water pressure adjusting unit 40 positioned at the rear end of the flow channel pipe to adjust an amount of water in order to inject water together with the detergent into the ejection nozzle by adjusting a water pressure of water discharged from the water tap; and
a water supply valve 50 connected to the rear end of the water pressure adjusting unit and the end portion of the water valve to supply water discharged from the water tap to the water pressure adjusting unit.

2. The hydrodynamic multipurpose washing device of claim 1, wherein the ejecting nozzle 20 comprises:
a brush 22 formed in cylindrical drum shape and for washing a washing object along a circumference of the front end;
an ejecting port 23 for ejecting a detergent and water in a high pressure toward a washing object at the center of the front end;
a water injection orifice pipe 24 for reducing a water amount area and increasing a water ejecting pressure toward an internal direction of the rear end of the ejecting port; and
a detergent injection orifice pipe 25 positioned in a direction of an angle 90° from one side of the water injection orifice pipe and for reducing a detergent amount area and increasing a detergent ejecting pressure.

3. The hydrodynamic multipurpose washing device of claim 2, wherein the ejecting nozzle 20 comprises:
a mixing space portion 26 formed in a portion in which the water injection orifice pipe and the detergent injection orifice pipe meet; and
a detergent check valve 27 for checking to inject a detergent in a direction toward an ejecting port at the mixing space portion.

4. The hydrodynamic multipurpose washing device of claim 1, wherein the flow channel pipe 30 comprises:
a water supply flow channel pipe 31 for injecting discharged water into the water injection orifice pipe of the ejecting nozzle according to a water pressure adjusted through the water pressure adjusting unit; and
a detergent flow channel pipe 32 comprising a circumference of the water supply flow channel pipe and for injecting a detergent into the detergent injection orifice pipe of the ejecting nozzle by a pushing force of the piston.

5. The hydrodynamic multipurpose washing device of claim 1, wherein the water pressure adjusting unit 40 comprises:
a cylindrical drum-shaped water pressure adjustment body 41;
a water supply flow channel pipe 31 penetrated at the center of the inside of the water pressure adjustment body;
a water injecting vent hole 43 for injecting water toward a piston space portion to generate a pushing force with a water pressure to a detergent piston at one side of the water supply flow path pipe positioned at a rear end portion of the water pressure adjustment body;
a water pressure adjustment valve 44 positioned at one side of the water injecting vent hole to adjust a water pressure with a straight type stop bar rotation method;
a piston 45 positioned in a front end direction of an internal piston space portion of the water pressure adjustment valve to push a detergent of a detergent storage tub toward a detergent injection orifice pipe; and
a detergent storage tub 46 for storing a detergent at the front end of the piston.

6. The hydrodynamic multipurpose washing device of claim 4, wherein the detergent storage tub 46 comprises:
a compression coil spring 46a for restoring a piston to an original state after a work is complete at a portion contacting with the piston and a periphery of a latch jaw of an end portion of the water pressure adjustment body;
a detergent cap 46b for supplying a detergent to the inside at one side of a circumference of the outside; and
an air check valve 46c for checking to inject air injected into the front end of a latch jaw of an end portion of the water pressure adjustment body in a direction of the detergent injection orifice pipe.
